(19) United States
(12) Patent Application Publication
(10) Pub. No.: US 2019/0139567 A1
(43) Pub. Date: May 9, 2019

(54) Voice Activity Detection Feature Based on Modulation-Phase Differences

(71) Applicant: Nuance Communications, Inc., Burlington, MA (US)

(72) Inventors: Simon Graf, Ulm (DE); Tobias Herbig, Ulm (DE); Markus Buck, Biberach (DE)

(21) Appl. No.: 16/095,265

(22) PCT Filed: Feb. 17, 2017
(86) PCT No.: PCT/US2017/018362

§ 371 Date: Oct. 19, 2018

Related U.S. Application Data
(60) Provisional application No. 62/338,884, filed on May 19, 2016.
(60) Provisional application No. 62/335,139, filed on May 12, 2016.

(51) Int. Cl. G10L 25/93; G10L 25/18; G10L 25/84

(52) U.S. Cl. CPC G10L 25/93; G10L 2025/932; G10L 25/84; G10L 25/18

(57) ABSTRACT

Speech processing methods may rely on voice activity detection (VAD) that separates speech from noise. Example embodiments of a computationally low complex VAD feature that is robust against various types of noise is introduced. By considering an alternating excitation structure of low and high frequencies, speech is detected with a high confidence. The computationally low complex VAD feature can cope even with the limited spectral resolution that may be typical for a communication system, such as an in-car-communication (ICC) system. Simulation results confirm the robustness of the computationally low complex VAD feature and show an increase in performance relative to established VAD features.

### RELATED APPLICATIONS

This application claims the benefit of U.S. Provisional Application No. 62/335,139, filed on May 12, 2016 and U.S. Provisional Application No. 62/338,884, filed on May 19, 2016. The entire teachings of the above applications are incorporated herein by reference.

### BACKGROUND

Voice Activity Detection (VAD), also known as speech activity detection or speech detection, may be relied upon by many speech/audio applications, such as speech coding, speech recognition, or speech enhancement applications, in order to detect a presence or absence of speech in a speech/audio signal. VAD is usually language independent. VAD may facilitate speech processing and may also be used to deactivate some processes during a non-speech section of an audio session to avoid unnecessary coding/transmission of silence in order to save on computation and network bandwidth.

### SUMMARY

According to an example embodiment, a method for detecting speech in an audio signal may comprise identifying a pattern of at least one occurrence of time-separated first and second distinctive feature values of first and second feature values, respectively, in at least two different frequency bands of an electronic representation of an audio signal of speech that includes voiced and unvoiced phonemes and noise. The identifying may include associating the first distinctive feature values with the voiced phonemes and the second distinctive feature values with the unvoiced phonemes. The first and second distinctive feature values may represent information distinguishing the speech from the noise. The time-separated first and second distinctive feature values may be non-overlapping, temporally, in the at least two different frequency bands. The method may comprise producing a speech detection result for a given frame of the electronic representation of the audio signal based on the pattern identified. The speech detection result may indicate a likelihood of a presence of the speech in the given frame.

The first feature values may represent power over time of the electronic representation of the audio signal in a first frequency band of the at least two frequency bands. The first distinctive feature values may represent a first concentration of power in the first frequency band. The second feature values may represent power over time of the electronic representation of the audio signal in a second frequency band of the at least two frequency bands. The second distinctive feature values may represent a second concentration of power in the second frequency band, wherein the first frequency band may be lower in frequency relative to the second frequency band.

The first feature values may represent degrees of harmonicity over time of the electronic representation of the audio signal in a first frequency band of the at least two frequency bands. The first distinctive feature values may represent non-zero degrees of harmonicity in the first frequency band. The second feature values may represent power over time of the electronic representation of the audio signal in a second frequency band of the at least two frequency bands. The second distinctive feature values may represent a concentration of power in the second frequency band, wherein the first frequency band may be lower in frequency relative to the second frequency band.

The identifying may include employing feature values accumulated in at least one previous frame to identify the pattern of time-separated first and second distinctive feature values, the at least one previous frame transpiring previous to the given frame.

The identifying may include computing phase differences between first modulated signal components of the electronic representation of the audio signal in a first frequency band of the at least two different frequency bands and second modulated signal components of the electronic representation of the audio signal in a second frequency band of the at least two different frequency bands, wherein the first frequency band may be lower in frequency relative to the second frequency band.

The identifying may include employing the phase differences computed to detect a temporal alternation of the time-separated distinctive features in the at least two different frequency bands. The likelihood of the presence of the speech may be higher in response to the temporal alternation being detected relative to the temporal alternation not being detected, and the pattern may be the temporal alternation.

The identifying may include applying a modulation filter to the electronic representation of the audio signal and the modulation filter may be based on a syllable rate of human speech.

In an event the speech detection result satisfies a criterion for indicating that speech is present, the producing may include extending, temporally, the speech detection result for the given frame by associating the speech detection result with one or more frames immediately following the given frame.

The speech detection result may be a first speech detection result indicating the likelihood of the presence of the speech in the given frame. The producing may include combining the first speech detection result with a second speech detection result indicating the likelihood of the presence of the speech in the given frame to produce a combined speech detection result indicating the likelihood of the presence of the speech in the given frame with improved robustness against false-alarms during absence of speech relative to the first speech detection result and the second speech detection result. The combined speech detection result may prevent an indication that the speech is present in the given frame in an event the first speech detection result indicates that the likelihood of the presence of the speech is not present at the given frame or during frames previous to the given frame. The combining may employ the second speech detection result to detect an end of the speech in the electronic representation of the audio signal.

The method may include producing the second speech detection result by averaging magnitudes of first modulated signal components of the electronic representation of the audio signal in a first frequency band of the at least two different frequency bands and second modulated signal components of the electronic representation of the audio signal in a second frequency band of the at least two different frequency bands.

According to another example embodiment, an apparatus for detecting speech in an audio signal may comprise an audio interface configured to produce an electronic representation of an audio signal of speech including voiced and unvoiced phonemes and noise. The apparatus may further comprise a processor coupled to the audio interface, the processor configured to implement an identification module configured to identify a pattern of at least one occurrence of time-separated first and second distinctive feature values of first and second feature values, respectively, in at least two different frequency bands of the electronic representation of the audio signal of speech including the voiced and unvoiced phonemes and noise. To identify the pattern, the identification module may be configured to associate the first distinctive feature values with the voiced phonemes and the second distinctive feature values with the unvoiced phonemes. The first and second distinctive feature values may represent information distinguishing the speech from the noise. The time-separated first and second distinctive feature values may be non-overlapping, temporally, in the at least two different frequency bands. The apparatus may still further comprise a speech detection module configured to produce a speech detection result for a given frame of the electronic representation of the audio signal based on the pattern identified. The speech detection result may indicate a likelihood of a presence of the speech in the given frame.

The first feature values may represent power over time of the electronic representation of the audio signal in a first frequency band of the at least two frequency bands. The first distinctive feature values may represent a first concentration of power in the first frequency band. The second feature values may represent power over time of the electronic representation of the audio signal in a second frequency band of the at least two frequency bands. The second distinctive feature values may represent a second concentration of power in the second frequency band, wherein the first frequency band may be lower in frequency relative to the second frequency band.

The first feature values may represent degrees of harmonicity over time of the electronic representation of the audio signal in a first frequency band of the at least two frequency bands. The first distinctive feature values may represent non-zero degrees of harmonicity in the first frequency band. The second feature values may represent power over time of the electronic representation of the audio signal in a second frequency band of the at least two frequency bands. The second distinctive feature values may represent a concentration of power in the second frequency band, wherein the first frequency band may be lower in frequency relative to the second frequency band.

The identification module may be further configured to compute phase differences between first modulated signal components of the electronic representation of the audio signal in a first frequency band of the at least two different frequency bands and second modulated signal components of the electronic representation of the audio signal in a second frequency band of the at least two different frequency bands. The first frequency band may be lower in frequency relative to the second frequency band.

The identification module may be further configured to employ the phase differences computed to detect a temporal alternation of the time-separated first and second distinctive features in the at least two different frequency bands. The likelihood of the presence of the speech may be higher in response to the temporal alternation being detected relative to the temporal alternation not being detected. The pattern may be the temporal alternation.

The identification module may be further configured to apply a modulation filter to the electronic representation of the audio signal. The modulation filter may be based on a syllable rate of human speech.

In an event the speech detection result satisfies a criterion for indicating that speech is present, the speech detection module may be further configured to extend, temporally, the speech detection result for the given frame by associating the speech detection result with one or more frames immediately following the given frame.

The speech detection result may be a first speech detection result indicating the likelihood of the presence of the speech in the given frame. The speech detection module may be further configured to combine the first speech detection result with a second speech detection result indicating the likelihood of the presence of the speech in the given frame to produce a combined speech detection result indicating the likelihood of the presence of the speech in the given frame with improved robustness against false-alarms during absence of speech relative to the first speech detection result and the second speech detection result. The combined speech detection result may prevent an indication that the speech is present in the given frame in an event the first speech detection result indicates that the likelihood of the presence of the speech is not present at the given frame or during frames previous to the given frame. The second speech detection result may be employed to detect an end of the speech in the electronic representation of the audio signal.

The speech detection module may be further configured to produce the second speech detection result by averaging magnitudes of first modulated signal components of the electronic representation of the audio signal in a first frequency band of the at least two different frequency bands and second modulated signal components of the electronic representation of the audio signal in a second frequency band of the at least two different frequency bands.

Yet another example embodiment may include a non-transitory computer-readable medium having stored thereon a sequence of instructions which, when loaded and executed by a processor, causes the processor to complete methods disclosed herein.

It should be understood that embodiments disclosed herein can be implemented in the form of a method, apparatus, system, or computer readable medium with program codes embodied thereon.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of an example embodiment of a car in which an example embodiment of an in-car-communication (ICC) system may be employed.

FIG. 2A is a spectrogram of an example embodiment of noisy speech.

FIG. 2B is another spectrogram of the example embodiment of noisy speech of FIG. 2A.

FIG. 3 is a flow diagram of an example embodiment of a method for detecting speech in an audio signal.

FIG. 4 is a plot of an example embodiment of first feature values of voiced signal feature values and second feature values of unvoiced signal feature values in different frequency bands over time.

FIG. 5 is a block diagram of an example embodiment of considerations for identifying a pattern of time-separated distinctive feature values.

FIG. 6 is a block diagram of an example embodiment of an apparatus for detecting speech in an audio signal.

FIG. 7 is a block diagram of example embodiments of spectrograms of different signal properties.

FIG. 8 is a graph of example embodiments of magnitude transfer functions of filters.

FIG. 9 is a block diagram of an example embodiment of a system for producing a voice activity detection (VAD) feature for detecting speech in an audio signal.

FIGS. 10A and 10B are graphs of an example embodiments of detection rates of different features plotted for a fixed false-alarm rate and two different sampling rates.

FIG. 11 is a graph of example embodiments of Receiver Operating Characteristic (ROC) curves for different features.

FIG. 12 is a block diagram of an example internal structure of a computer optionally within an embodiment disclosed herein.

### DETAILED DESCRIPTION

Example embodiments produce VAD features for speech detection (referred to interchangeably herein as voice activity detection (VAD) or speech activity detection) that robustly distinguish between speech and interfering noise. In contrast to features described in previous publications, an example embodiment of a VAD feature explicitly takes into account a temporally alternating structure of voiced and unvoiced speech components, as well as a typical syllable rate of human speech. A low frequency resolution of the spectrum is sufficient to determine the VAD feature according to the example embodiment, enabling a computationally low-complex feature. According to an example embodiment, the VAD feature may obviate a need for spectral analysis of an audio signal for many frequency bands, thus, reducing a number of frequency bins otherwise employed for VAD.

An example embodiment disclosed herein may exploit a temporal alternation of voiced and unvoiced phonemes for VAD. In contrast to speech recognizers that employ complex models of phoneme sequences to identify spoken utterances, the example embodiment disclosed herein may employ detection of the temporal alternation. It should be understood that speech recognizers are employed for a different application, that is, speech recognition versus speech detection. An example embodiment disclosed herein may produce a speech detection result that may be used by a speech recognition application in order to understand whether a sequence of audio samples has speech to know when to perform speech recognition processing and may improve the speech recognition application based on improved VAD.

As disclosed above, speech processing methods may rely on VAD that separates speech from noise. For this task, several features have been introduced in literature that employ different characteristic properties of speech. An embodiment disclosed herein introduces a VAD feature that is robust against various types of noise. By considering an alternating excitation structure of low and high frequencies, speech may be detected with a high confidence, as disclosed further below. The example embodiment may be a computationally low-complex feature that can cope even with a limited spectral resolution that may be typical for in-car-communication (ICC) systems, as disclosed further below. As disclosed further below, simulations confirm robustness of an example embodiment of a VAD feature disclosed herein and show an increasing performance compared to established VAD features.

VAD is an essential prerequisite for many speech processing methods (J. Ramirez, J. M. Górriz, and J. C. Segura, “Voice Activity Detection. Fundamentals and Speech Recognition System Robustness,” in Robust Speech Recognition and Understanding (M. Grimm and K. Kroschel, eds.), pp. 1-22, Intech, 2007). In automotive scenarios, different applications may benefit from VAD: speech controlled applications, such as navigation systems, achieve more accurate recognition results when only speech intervals are taken into account. Hands-free telephony allows the passengers to make phone calls with high speech quality out of the driving car. In-car-communication (ICC) systems (G. Schmidt and T. Haulick, “Signal processing for in-car communication systems,” Signal processing, vol. 86, no. 6, pp. 1307-1326, 2006, C. Luke, H. Özer, G. Schmidt, A. Theiß, and J. Withopf, “Signal processing for in-car communication systems,” in 5^{th} Biennial Workshop on DSP for In-Vehicle Systems, Kiel, Germany, (Kiel, Germany), 2011) even facilitate conversations inside the passenger cabin. Many of the incorporated speech enhancement methods, such as noise estimation, focus on time intervals where either speech is present or where the signal purely consists of noise.

In ICC systems (G. Schmidt and T. Haulick, “Signal processing for in-car communication systems,” Signal processing, vol. 86, no. 6, pp. 1307-1326, 2006, C. Luke, H. Özer, G. Schmidt, A. Theiß, and J. Withopf, “Signal processing for in-car communication systems,” in 5^{th} Biennial Workshop on DSP for In-Vehicle Systems, Kiel, Germany, (Kiel, Germany), 2011), one passenger's speech is recorded by speaker-dedicated microphones and an enhanced signal is immediately played back by a loudspeaker close to another passenger. These systems allow for a convenient communication between passengers even under adverse noise conditions at high speeds. Speech enhancement techniques may be employed to process a microphone signal and generate the enhanced signal played on the loudspeaker that may be adjusted to an acoustic environment of the car.

Special constraints may be considered in an ICC system that take effect on the design of the VAD. Since both the original speech and the processed signal are accessible in parallel by the passengers, latency is a more critical issue compared to other applications, such as speech recognition or hands-free telephony. System latencies of more than 10 ms result in reverberations that are perceived as annoying by the passengers (G. Schmidt and T. Haulick, “Signal processing for in-car communication systems,” Signal processing, vol. 86, no. 6, pp. 1307-1326, 2006). Therefore, the signal is typically processed using very small block sizes and small window lengths. Small window lengths and high sampling rates result in a low frequency resolution of the spectrum. Therefore, fine-structured harmonic components of speech can barely be observed from the spectrum. Only the format structure of speech is reflected by the envelope of the spectrum.

Several features for VAD have been introduced that represent characteristic properties of speech (S. Graf, T. Herbig, M. Buck, and G. Schmidt, “Features for voice activity detection: a comparative analysis,” EURASIP Journal on Advances in Signal Processing, vol. 2015, November 2015). Some of these features rely on a high frequency resolution and are, therefore, not directly applicable in ICC. Instead, given the constraints for ICC applications, features that employ information from the spectral envelope or from temporal variations of the signal come into consideration.

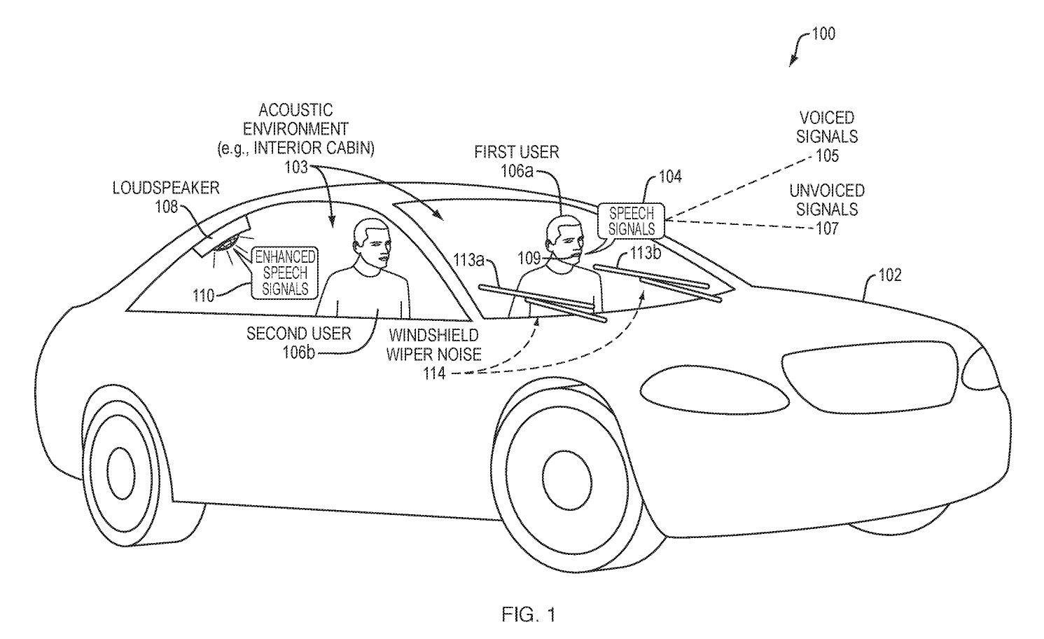

An example embodiment disclosed herein may be employed in a variety of in-car-communication (ICC) systems; however, it should be understood that embodiments disclosed herein are not limited to ICC applications. An ICC system may support communications paths within a car by receiving speech signals of a speaking passenger via a microphone or other suitable sound receiving device and playing back such speech signals for one or more listening passengers via a loudspeaker or other suitable electroacoustic transducer. In ICC applications, frequency resolution of the spectrum is much lower compared to other applications, as disclosed above. An example embodiment disclosed herein may cope with such a constraint that may be applicable in an ICC system, such as the ICC system of FIG. 1, disclosed below, or any other speech/audio system.

FIG. 1 is a block diagram 100 of an example embodiment of a car 102 in which an example embodiment of an in-car-communication (ICC) system (not shown) may be employed. The ICC system supports a communications path (not shown) within the car 102 and receives speech signals 104 of a first user 106a via a microphone (not shown) and plays back enhanced speech signals 110 on a loudspeaker 108 for a second user 106b. A microphone signal (not shown) produced by the microphone may include both the speech signals 104 as well as noise signals (not shown) that may be produced in an acoustic environment 103, such as the interior cabin of the car 102.

The microphone signal may be enhanced by the ICC system based on differentiating acoustic noise produced in the acoustic environment 103, such as windshield wiper noise 114 produced by the windshield wiper 113a or 113b or other acoustic noise produced in the acoustic environment 103 of the car 102, from the speech signals 104 to produce the enhanced speech signals 110 that may have the acoustic noise suppressed. It should be understood that the communications path may be a bi-directional path that also enables communication from the second user 106b to the first user 106a. As such, the speech signals 104 may be generated by the second user 106b via another microphone (not shown) and the enhanced speech signals 110 may be played back on another loudspeaker (not shown) for the first user 106a.

The speech signals 104 may include voiced signals 105 and unvoiced signals 107. The speaker's speech may be composed of voiced phonemes, produced by the vocal cords (not shown) and vocal tract including the mouth and lips 109 of the first user 106a. As such, the voiced signals 105 may be produced when the speaker's vocal cords vibrate during pronunciation of a phoneme. The unvoiced signals 107, by contrast, do not entail use of the speaker's vocal cords. For example, a difference between the phonemes /s/ and /z/ or /f/ and /v/ is vibration of the speaker's vocal cords. The voiced signals 105 may tend to be louder like the vowels /a/, /e/, /i/, /u/, /o/, than the unvoiced signals 107. The unvoiced signals 107, on the other hand, may tend to be more abrupt, like the stop consonants /p/, /t/, /k/.

It should be understood that the car 102 may be any suitable type of transport vehicle and that the loudspeaker 108 may be any suitable type of device used to deliver the enhanced speech signals 110 in an audible form for the second user 106b. Further, it should be understood that the enhanced speech signals 110 may be produced and delivered in a textual form to the second user 106b via any suitable type of electronic device and that such textual form may be produced in combination with or in lieu of the audible form.

An example embodiment disclosed herein may be employed in an ICC system, such as disclosed in FIG. 1, above, to produce the enhanced speech signals 110. An example embodiment disclosed herein may be employed by speech enhancement techniques that process the microphone signal including the speech signals 104 and acoustic noise of the acoustic environment 103 and generate the enhanced speech signals 110 that may be adjusted to the acoustic environment 103 of the car 102.

An example embodiment disclosed herein may cope with a very low frequency resolution in a spectrum that may result from special conditions, such as the small window lengths, high sampling rate, low Fast Fourier Transform (FFT) lengths that may be employed in an ICC system, limiting spectral resolution, as disclosed above. An example embodiment disclosed herein may consider a temporally alternating excitation structure of low and high frequencies corresponding to voiced and unvoiced phonemes, respectively, such as the voiced and unvoiced phonemes disclosed above with reference to FIG. 1, as well as a typical syllable rate of human speech.

By considering multiple speech characteristics, an example embodiment disclosed herein may achieve an increase in robustness against interfering noises. Example embodiments disclosed herein may be employed in a variety of speech/audio applications, such as speech coding, speech recognition, speech enhancement applications, or any other suitable speech/audio application in which VAD may be applied, such as the ICC application disclosed in FIG. 1, above.

An example embodiment disclosed herein may employ a temporally alternating concentration of power in low and high frequencies or, alternatively, a temporally alternating concentration of non-zero degrees of harmonicity in the low frequencies and power in the high frequencies, to indicate an alternating occurrence of voiced and unvoiced phonemes. Modulation may be employed to quantify a temporal profile of a speech signal's variations and phase differences of modulation between different frequency bands may be employed to detect the alternating structure providing an improvement over modulation features that may consider magnitude alone.

Embodiments disclosed herein take into account modulation frequencies next to the typical syllable rate of human speech of about 4 Hz (E. Scheirer and M. Slaney, “Construction and evaluation of a robust multifeature speech/music discriminator,” in ICASSP, vol. 2, (Munich, Germany), pp. 1331-1334, April 1997). In earlier publications, e.g., (J.-H. Bach, B. Kollmeier, and J. Anemilller, “Modulation based detection of speech in real background noise: Generalization to novel background classes,” in ICASSP, (Dallas, Tex., USA), pp. 41-44, 2010), modulation was identified as a good indicator for the presence of speech since it reflects the characteristic temporal structure. According to an example embodiment disclosed herein, phase differences of the modulation between high and low frequencies may be employed to detect the presence of speech more robustly. Further, by employing, additionally, a modulation feature, embodiments disclosed herein may further improve performance, as disclosed further below.

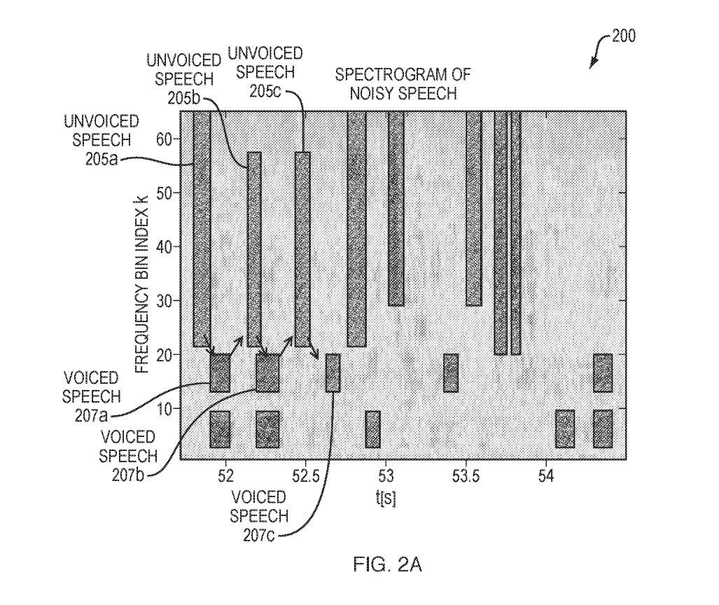

FIG. 2A is a spectrogram 200 of an example embodiment of noisy speech. In the spectrogram 200, a spectral fine structure that includes harmonics is not captured by the spectrum due to the low frequency resolution that may be typical in an ICC system, as disclosed above. The spectrogram 200 does, however, show a characteristic pattern for speech that shows an alternation of unvoiced and voiced speech. For example, the spectrogram 200 shows a characteristic pattern of power concentrations in frequency bands indicating a pattern of unvoiced speech 205a, followed by voiced speech 207a, followed by unvoiced speech 205b, followed by voiced speech 207b, followed by unvoiced speech 205c, followed by voiced speech 207c, and so on.

FIG. 2B is another spectrogram 220 of the example embodiment of noisy speech of FIG. 2A. In the spectrogram 220, a first temporal variation of power 216 that fluctuates with a frequency of 4 Hz in a first frequency band and a second temporal variation of power 218 that fluctuates with the frequency of 4 Hz in a second frequency band are shown, wherein the first frequency band may be lower in frequency relative to the second frequency band. Embodiments disclosed herein may exploit the nearly alternating occurrence of low and high frequency speech components as shown in FIGS. 2A and 2B. Embodiments disclosed herein may exploit the 180° phase difference between the first temporal variation of power 216 that fluctuates with a frequency of 4 Hz in the first frequency band and the second temporal variation of power 218 that fluctuates with the frequency of 4 Hz in the second frequency band. According to an example embodiment, the first frequency band includes frequencies from 200 Hz to 2 kHz and the second frequency band includes frequencies from 4.5 kHz to 8 kHz. The underlying speech characteristics that are exploited are disclosed in more detail, further below.

According to an example embodiment, speech detection may employ two characteristic properties of human speech to distinguish speech from pure noise. A typical syllable rate of speech of about 4 Hz may be utilized by considering modulations in this frequency range. Furthermore, an alternating structure of voiced and unvoiced speech, such as disclosed in FIGS. 2A and 2B, above, may be captured by considering phase differences of the modulation between the lower and higher frequency bands, as disclosed further below.

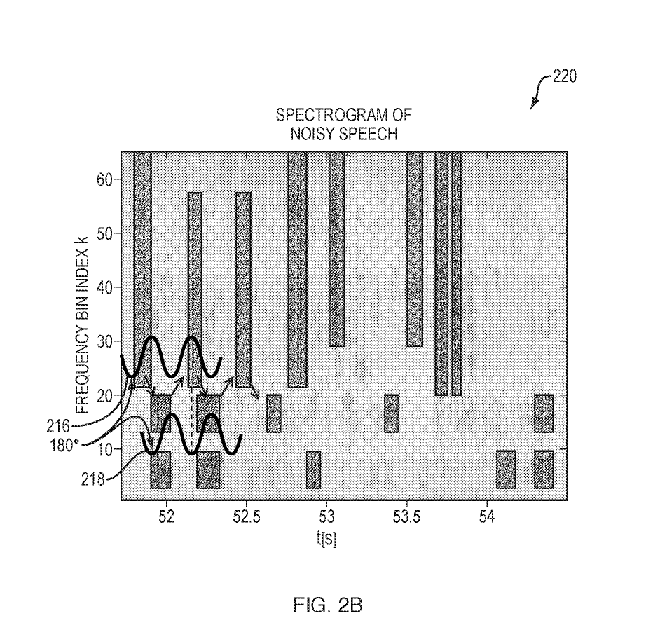

FIG. 3 is a flow diagram 300 of an example embodiment of a method for detecting speech in an audio signal. The method may begin (320) and identify a pattern of at least one occurrence of time-separated first and second distinctive feature values of first and second feature values, respectively, in at least two different frequency bands of an electronic representation of an audio signal of speech that includes voiced and unvoiced phonemes and noise (322). The identifying may include associating the first distinctive feature values with the voiced phonemes and the second distinctive feature values with the unvoiced phonemes. The first and second distinctive feature values may represent information distinguishing the speech from the noise. The time-separated first and second distinctive feature values may be non-overlapping, temporally, in the at least two different frequency bands. The method may produce a speech detection result for a given frame of the electronic representation of the audio signal based on the pattern identified (324). The speech detection result may indicate a likelihood of a presence of the speech in the given frame. The method thereafter ends (326), in the example embodiment.

According to an example embodiment, the speech detection result may indicate a probability that speech is present, for example, via a probability value in a range between 0 and 1, or any other suitable range of values.

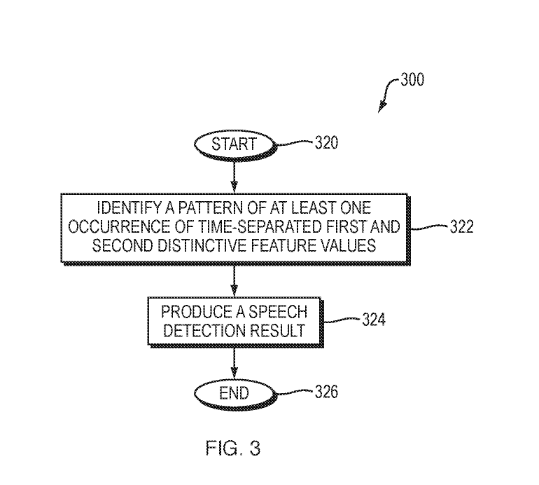

FIG. 4 is a plot 400 of an example embodiment of first feature values 419 of voiced signal feature values 405 and second feature values 421 of unvoiced signal feature values 407 in different frequency bands (not shown) over time 401. The first feature values 419 may be concentrations of power or degrees of harmonicity gathered over the time 401 in a first frequency band (not shown) of the different frequency bands. The second feature values 421 may be concentrations of power gathered over the time 401 in a second frequency band (not shown) of the different frequency bands. The first frequency band may be lower in frequency relative to the second frequency band.

An example embodiment of a VAD feature may identify a pattern of time-separated occurrence of voiced and unvoiced phonemes. Identifying the voiced and unvoiced phonemes may be based on detecting concentrations of power in the different frequency bands. Alternatively, identifying the voiced and unvoiced phonemes may be based on detecting a concentration of harmonic components in the first frequency band and a concentration of power in the second frequency band. Voiced speech may be represented by a high value of the VAD feature. By using a harmonicity-based feature, such as auto-correlation maximum, to detect the concentration of harmonic components, voiced speech may be detected based on the high value of the VAD feature resulting from a harmonic concentration value instead of a power concentration value in the lower frequency band, that is, the first frequency band, disclosed above.

As disclosed above, speech includes both voiced and unvoiced phonemes. The terms “voiced” and “unvoiced” refer to a type of excitation, such as a harmonic or noise-like excitation. For example, for voiced phonemes, periodic vibrations of the vocal cords result in the harmonic excitation. Some frequencies, the so-called “formants,” are emphasized due to resonances of the vocal tract. Primarily low frequencies are emphasized that may be captured by the first frequency band. Unvoiced phonemes are generally produced by a constriction of the vocal tract resulting in the noise-like excitation (turbulent airflow) which does not exhibit harmonic components. Primarily high frequencies are excited that are captured by the second frequency band.

Some values of the voiced signal feature values 405 and unvoiced signal feature values 407 are distinctive, that is, some values may be prominent feature values that are distinctively higher relative to other feature values, such as the first distinctive feature values 415 of the first feature values 419 and the second distinctive feature values 417 of the second feature values 421. According to an example embodiment, speech detection may be triggered in an event an occurrence of distinctive feature values of the first and second feature values is time-separated (i.e., non-overlapping, temporally), such as the occurrence of time-separated first and second distinctive feature values 423 shown in the plot 400. The first distinctive feature values 415 and the second distinctive feature values 417 may represent information distinguishing speech from noise and the time-separated first distinctive feature values 415 and the second distinctive feature 417 are non-overlapping, temporally, in the first and second frequency bands, as indicated by the occurrence of time-separated first and second distinctive feature values 423. The first distinctive feature values 415 and the second distinctive feature values 417 may represent prominent feature values distinctively higher relative to other feature values of the voiced signal feature values 405 and the unvoiced signal feature values 407, respectively, separating the first distinctive feature values 415 and the second distinctive feature values 417 from noise.

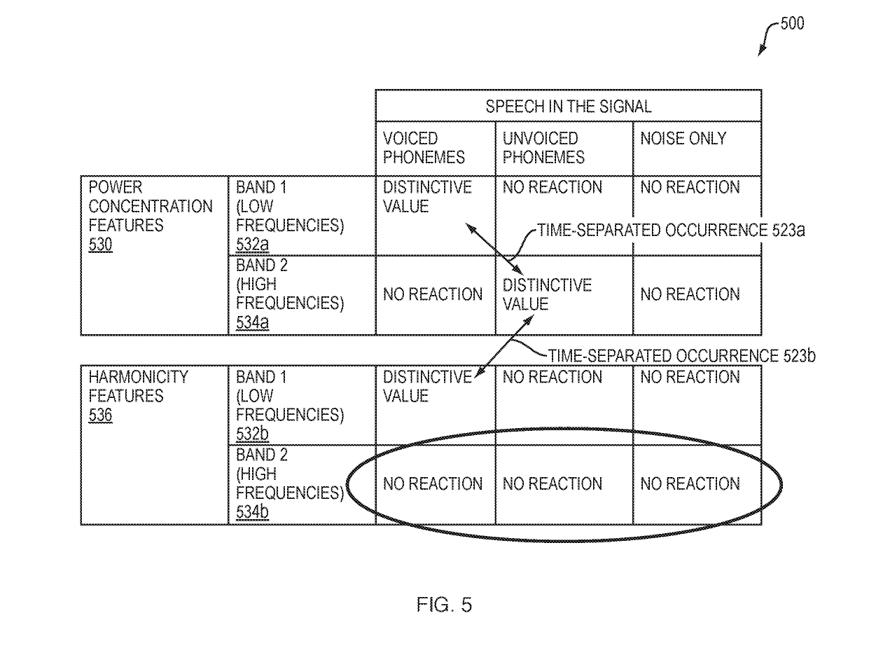

Embodiments disclosed herein may produce a speech detection result, such as the speech detection result 662 of FIG. 6, disclosed further below, for a given frame of an electronic representation of an audio signal of speech that includes voiced and unvoiced phonemes and noise based on identifying a pattern of time-separated distinctive feature values, such as the time-separated first and second distinctive feature values 415 and 417. The speech detection result may indicate a likelihood of a presence of the speech in the given frame. The speech detection result indicating the likelihood of the presence of the speech in the given frame may be considered along with other speech detection results of other frames to produce a determination of speech presence. Alternatively, the speech detection result for the given frame may be used in isolation to produce the determination of speech presence.

A frame, corresponding to the variable [symbol] employed in the equations following below, may correspond to a time interval of a sequence of audio samples in an audio signal, wherein the time interval may be shifted for each [symbol] . For example, a frame corresponding to [symbol] =1 may include an initial 128 samples from the audio signal whereas another frame corresponding to [symbol] =2 may include a next 128 samples from the audio signal, wherein the initial 128 samples and the next 128 samples may overlap as the frames corresponding to [symbol] =1 and [symbol] =2 may be overlapping frames.

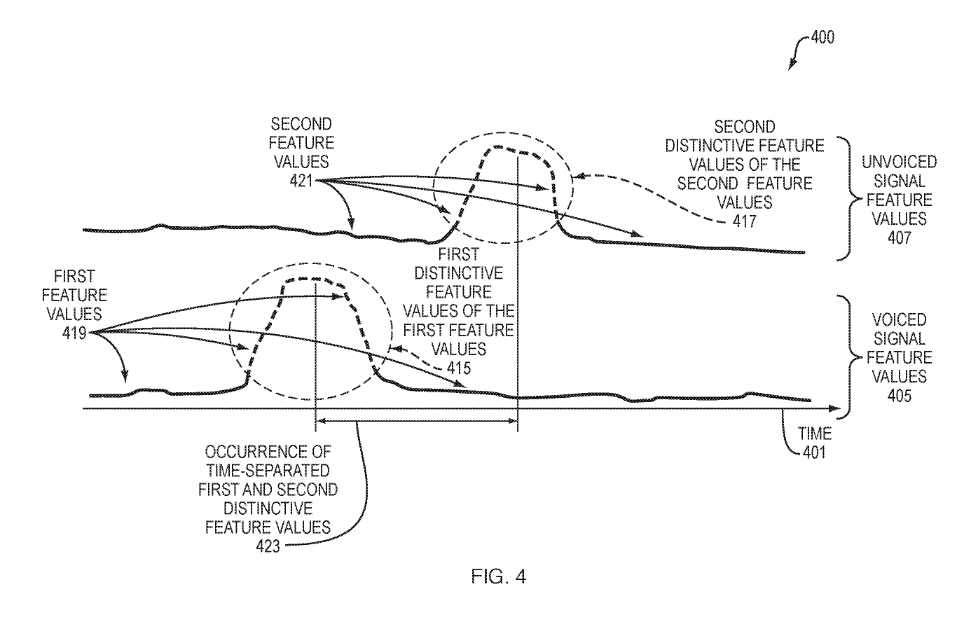

FIG. 5 is a block diagram 500 of an example embodiment of considerations for identifying a pattern of time-separated distinctive feature values, such as the time-separated first and second distinctive feature values 415 and 417 of an audio signal of speech that includes voiced and unvoiced phonemes and noise, disclosed in FIG. 4, above. According to an example embodiment, a pattern of time-separated distinctive feature values may be identified by identifying a time-separated occurrence 523a of power concentration features 530 in a first frequency band of low frequencies 532a and in a second frequency band of high frequencies 534a.

Alternatively, the pattern of time-separated distinctive feature values may be a time-separated occurrence 523b that may be identified by identifying the power concentration features 530 for the second frequency band of high frequencies 534a and instead of the power concentration features 530, harmonicity features 536 may be detected in the first frequency band of low frequencies 532b. As shown in the block diagram 500, the harmonicity features 536 as applied to the higher frequencies 534b do not contain any information about the presence or absence of speech, as indicated by “no reaction” in the block diagram 500.

As such, turning back to FIG. 4, the first feature values 419 may represent power over time of an electronic representation of an audio signal in a first frequency band of at least two frequency bands. The first distinctive feature values 415 may represent a first concentration of power in the first frequency band. The second feature values 421 may represent power over time of the electronic representation of the audio signal in a second frequency band of the at least two frequency bands. The second distinctive feature values 417 may represent a second concentration of power in the second frequency band, wherein the first frequency band may be lower in frequency relative to the second frequency band.

Alternatively, the first feature values 419 may represent degrees of harmonicity over time of the electronic representation of the audio signal in a first frequency band of the at least two frequency bands. The first distinctive feature values 415 may represent non-zero degrees of harmonicity in the first frequency band. The second feature values 421 may represent power over time of the electronic representation of the audio signal in a second frequency band of the at least two frequency bands. The second distinctive feature values 417 may represent a concentration of power in the second frequency band, wherein the first frequency band may be lower in frequency relative to the second frequency band.

FIG. 6 is a block diagram 600 of an example embodiment of an apparatus 650 for detecting speech in an audio signal. The apparatus 650 may comprise an audio interface 652 configured to produce an electronic representation 658 of an audio signal of speech including voiced and unvoiced phonemes and noise 609. The apparatus 650 may further comprise a processor 654 coupled to the audio interface 652. The processor 654 may be configured to implement an identification module 656 configured to identify a pattern of at least one occurrence of time-separated first and second distinctive feature values of first and second feature values, respectively, in at least two different frequency bands of the electronic representation 658 of the audio signal of speech including the voiced and unvoiced phonemes and noise 609.

To identify the pattern, the identification module 656 may be configured to associate the first distinctive feature values, such as the first distinctive feature values 415 of FIG. 4, disclosed above, with the voiced phonemes, and the second distinctive feature values, such as the second distinctive feature values 417 of FIG. 4, disclosed above, with the unvoiced phonemes. The first and second distinctive feature values may represent information distinguishing the speech from the noise. The time-separated first and second distinctive feature values may be non-overlapping, temporally, in the at least two different frequency bands.

The apparatus 650 may still further comprise a speech detection module 660 configured to produce a speech detection result 662 for a given frame (not shown) of the electronic representation of the audio signal 658 based on the pattern identified. The speech detection result 662 may indicate a likelihood of a presence of the speech in the given frame.

Embodiments disclosed herein may exploit a nearly alternating occurrence of low and high frequency speech components. In the following, the underlying speech characteristics that are exploited are disclosed in more detail. Subsequently, an example embodiment of a VAD feature is introduced that uses both modulation and phase differences to indicate the presence of speech. In addition, in another example embodiment of the VAD feature, a contribution of magnitude and phase information to the VAD feature performance is evaluated. An example embodiment of the VAD feature performance is compared to established, however, more complex VAD features, as disclosed further below.

Speech Characteristics

Several different characteristic properties of speech can be employed to distinguish speech from noise (S. Graf, T. Herbig, M. Buck, and G. Schmidt, “Features for voice activity detection: a comparative analysis,” EURASIP Journal on Advances in Signal Processing, vol. 2015, November 2015). A first indicator for presence of speech is given by the signal's power. High power values may be caused by speech components; however, power-based features are vulnerable against various types of noise. An example embodiment of a VAD feature disclosed herein may also take into account a temporal or spectral structure of speech.

Improvements can be achieved by considering the non-stationarity of the signal. Typically, the background noise is more stationary compared to speech. This is employed, e.g., by the long-term signal variability (LTSV) feature (P. K. Ghosh, A. Tsiartas, and S. Narayanan, “Robust voice activity detection using long-term signal variability,” IEEE Transactions on Audio, Speech, and Language Processing, vol. 19, no. 3, pp. 600-613, 2011) that evaluates the temporal entropy

H(k, [symbol] )=− [symbol] Φₓₓ(k, [symbol] − [symbol] ′)·log(Φₓₓ(k, [symbol] − [symbol] ′))

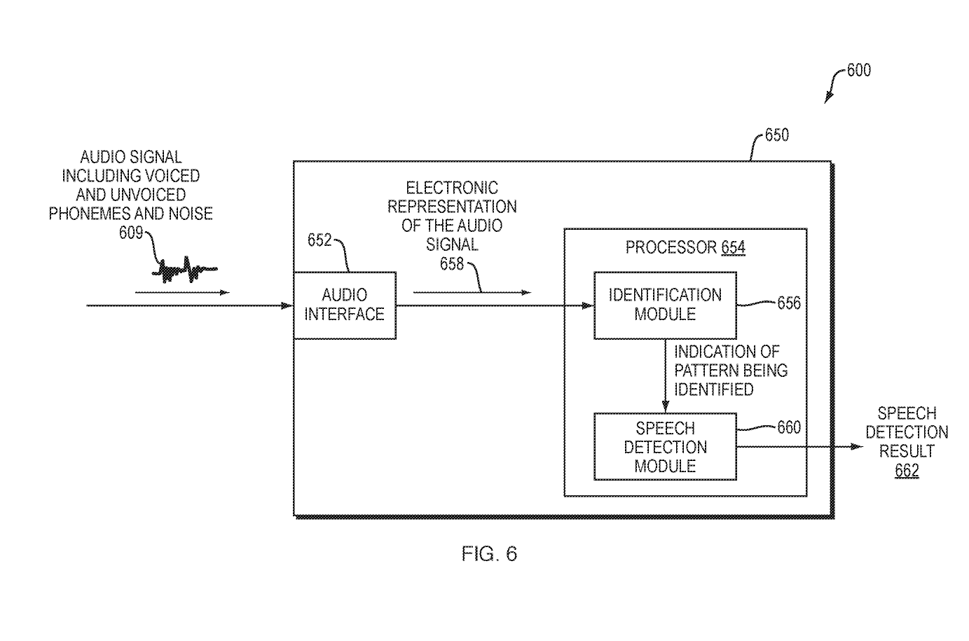

of the power spectrum Φxx(k, [symbol] ). Here, k indicates the frequency index, whereas the frame index is denoted by [symbol] . However, non-stationarity only reflects that the power spectrum varies over time, as illustrated in the bottom spectrogram 774 of FIG. 7, disclosed below.

FIG. 7 is a block diagram of example embodiments of spectrograms including a top spectrogram 770, middle spectrogram 772, and bottom spectrogram 774 of different signal properties. Different signal properties can be employed to detect speech as illustrated by means of speech spectrograms: non-stationary components in the signal may indicate speech. However, interferences result in non-stationarities, too. Modulation reflects the sequential structure of human speech and is, therefore, more robust against interferences. An embodiment disclosed herein may focus on alternating excitations of low and high frequencies. These alternations occur frequently in speech but rarely in noise.

Many interferences, such as a car's signal indicator or wiper noise, also result in fast variations of the power spectrum. More advanced features, therefore, consider the manner of the power spectrum's variations. Human speech consists of a sequence of different phonemes. Modulation-based features are capable to reflect this sequential structure by investigating the temporal profile (E. Scheirer and M. Slaney, “Construction and evaluation of a robust multifeature speech/music discriminator,” in ICASSP, vol. 2, (Munich, Germany), pp. 1331-1334, April 1997, J.-H. Bach, B. Kollmeier, and J. Anemüller, “Modulation based detection of speech in real background noise: Generalization to novel background classes,” in ICASSP, (Dallas, Tex., USA), pp. 41-44, 2010) as illustrated in the middle spectrogram 772 of FIG. 7. Modulations next to the typical syllable rate of human speech in the range of 4 Hz indicate presence of speech. By employing this structure, features are more robust against non-stationary interferences. However, modulation typically only reflects a temporal structure of speech but does not consider relationships between different frequencies.

An example embodiment of a VAD feature disclosed herein may assume an alternating structure of voiced and unvoiced phonemes. The corresponding alternating excitations of low and high frequencies is illustrated in the top spectrogram 770 of FIG. 7. By considering both the temporal and the spectral structure of speech, an example embodiment of a VAD feature disclosed herein may be more robust against various types of interferences.

Modulation-Phase Difference Feature

An example embodiment disclosed herein may exploit the alternating structure of low and high frequencies by determining phase differences of modulated signal components between different frequency bands. In a pre-processing step, a magnitude spectrum of the audio signal may be compressed to two frequency bands and stationary components removed. Modulations of the non-stationary components may be determined and normalized with respect to a temporal variance of the spectrum. Phase differences between both frequency bands may be taken into account, improving robustness of the example embodiments of the VAD features as compared to conventional modulation features. In the following, example embodiments for processing an input signal are disclosed in more detail.

Pre-Processing

According to an example embodiment, a pre-emphasis filter may be applied to the input audio signal in order to reduce noise in low frequencies, such as automotive noise, and to emphasize frequencies that are relevant for speech. The resulting signal may be transferred to a frequency domain using a short-time Fourier transform (STFT). As disclosed above, a window length and frame-shift may be very low, such as in an ICC application. According to an example embodiment, a Hamming window of 128 samples and a low frame-shift R=32 samples may be employed.

A magnitude spectrum |X(k, [symbol] )| of the [symbol] -th frame may be accumulated along the frequency bins k

$$B ( w , 𝓁 ) = \frac{1}{{k}_{max} ( w ) - {k}_{min} ( w ) + 1} {\sum }_{k = {k}_{min} ( w )}^{{k}_{max} ( w )} \vert X ( k , 𝓁 ) \vert \qquad ( 1 )$$

to capture the excitation of low and high frequencies by different frequency bands. Embodiments disclosed herein may employ two frequency bands w∈{1,2} that capture low frequencies [200 Hz, 2 kHz] and high frequencies [4.5 kHz, 8 kHz] corresponding to voiced and unvoiced speech, respectively.

According to an example embodiment, stationary components, corresponding to modulation frequency zero, may be removed by applying a high-pass filter

Bₕₚ(w, [symbol] )=(1+β₁)B(w, [symbol] )−B(w, [symbol] −1))/2

+β₁·Bₕₚ(w, [symbol] −1) (2)

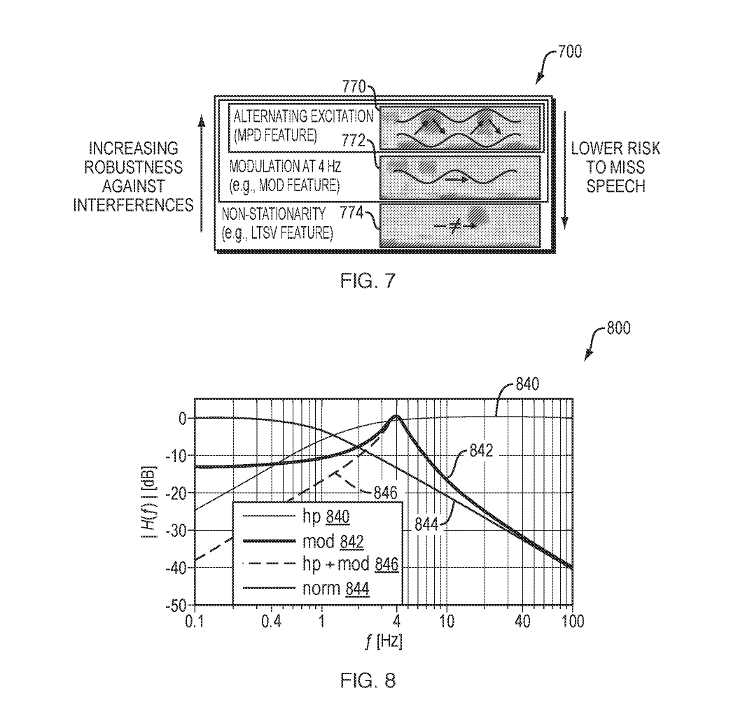

to each frequency band. The slope of the filter may be controlled by a parameter β₁=10^{-4.8·R/fs} [symbol] −48 dB/s, wherein fₛ is the sampling rate. FIG. 8 depicts the transfer function 840 of such a filter, as disclosed below.

FIG. 8 is a graph 800 of example embodiments of magnitude transfer functions of filters including a transfer function of a highpass filter 840 (hp, Eq. (2)), disclosed above, as well as a transfer function of a modulation filter 842 (mod, Eq. (3)) and a transfer function of a filter for normalization 844 (norm, Eq. (4)), disclosed further below. In addition, a transfer function of a combination of high-pass and modulation (hp+mod) filter 846 is plotted to illustrate which modulation frequencies are taken into account according to example embodiments disclosed herein.

Modulation Filter

According to an example embodiment, the VAD feature may investigate non-stationary components that are modulated with a frequency Ω_{mod} [symbol] 4 Hz corresponding to the syllable rate of human speech. By applying a band-pass filter

B_{mod}(w, [symbol] )=(1−β₂)Bₕₚ(w, [symbol] )

+β₂·B_{mod}(w, [symbol] −1)·e^{2πjΩ}^{_{mod}}, (3)

embodiments disclosed herein achieve complex-valued signals where the modulation frequency is emphasized as illustrated in the transfer function of a combination of high-pass and modulation (hp+mod) filter 846 of FIG. 8. A temporal context that is considered by the filter is controlled by an exponential decay parameter β₂. The example embodiment may employ a parameter β₂ [symbol] −24 dB/s to capture approximately two periods of the 4 Hz wave.

The complex values can be separated into phase and magnitude that both contain valuable information about the signal. The phase of B_{mod}(w, [symbol] ) captures information where power is temporally concentrated. Values next to zero indicate that at frame [symbol] the frequencies in the frequency band w are excited. In contrast, a phase next to ±π corresponds to excitation in the past, a half period ago.

The magnitude value represents the degree of modulation. High values indicate speech, whereas absence of speech results in low values next to zero. Since the magnitude still depends on the scaling of the input signal, embodiments disclosed herein apply normalization.

Normalization

An example embodiment may normalize the modulation signal with respect to the variance in each frequency band to acquire a VAD feature that is independent from the scaling of the input signal. The variance

Bₙₒᵣₘ²(w, [symbol] )=(1−β₃)Bₕₚ²(w, [symbol] )

+β₃·Bₙₒᵣₘ²(w, [symbol] −1) (4)

may be estimated by recursive smoothing of Bₕₚ² (w, [symbol] ) with a smoothing constant β₃=β₂ [symbol] −24 dB/s. The transfer function of the filter is depicted in the transfer function of the filter with normalization 844 of FIG. 8. After normalizing the modulation signal

\tilde{B}(w, [symbol] )=B_{mod}(w, [symbol] )/\sqrt{Bₙₒᵣₘ²(w, [symbol] )} (5)

the magnitude of \tilde{β}(w, [symbol] ) represents the contribution of the modulation frequency to the overall non-stationary signal components. Magnitude as well as phase information from both frequency bands may be combined in an example embodiment of the VAD feature to increase robustness against interferences.

Magnitude and Phase Differences

According to an example embodiment, magnitude as well as phase difference may be taken into account to detect an alternating excitation of low and high frequencies:

MPD( [symbol] )=−|\tilde{B}(1, [symbol] )|·|\tilde{B}(2, [symbol] )|

·cos(∠(\tilde{B}(1, [symbol] )·\tilde{B}*(2, [symbol] )). (6)

High feature values next to one indicate a distinct modulation and alternating excitation of the low and high frequencies. In this case, the magnitudes of both frequency bands are close to one and the cosine of the phase difference results in −1. In an event no distinct modulation is present, an example embodiment of the VAD feature assumes values next to zero since at least one magnitude is zero. Negative feature values indicate a distinct modulation but no alternating excitation structure.

Since the cosine function employed in Equation (6), disclosed above, produces a continuous value in a range [−1, 1], it may be employed to detect values close to +1, −1, or 0, enabling the scalar product disclosed in Equation (6) to be used to detect 180° phase shift, corresponding to values close to +1 or −1, or no phase difference, corresponding to values close to 0. As such, according to the example embodiment of Equation (6), disclosed above, a VAD feature may employ detection of both modulation, for example 4 Hz, as well as a specific phase shift (i.e., phase difference), such as a 180° phase shift, between high and low frequencies to determine a likelihood of the presence of speech for a time interval of speech corresponding to a given frame [symbol] . The 180° phase shift may be determined based on the scalar product employing a cosine, as in Equation (6), disclosed above, or by shifting one of the two cosines of the scalar product in time and summing the two cosines to get a maximum value.

According to embodiments disclosed herein, an example embodiment of the VAD feature may be implemented, efficiently, by:

MPD( [symbol] )=−(Re{\tilde{B}(1, [symbol] )}·Re{\tilde{B}(2, [symbol] )}

+Im{\tilde{B}(1, [symbol] )}·Im{\tilde{B}(2, [symbol] )}). (7)

A conventional modulation feature, similar to (E. Scheirer and M. Slaney, “Construction and evaluation of a robust multifeature speech/music discriminator,” in ICASSP, vol. 2, (Munich, Germany), pp. 1331-1334, April 1997), can be derived by averaging the magnitudes of both frequency bands

$$MOD ( 𝓁 ) = \frac{\vert \tilde{B} ( 1 , 𝓁 ) \vert + \vert \tilde{B} ( 2 , 𝓁 ) \vert}{2} \qquad ( 8 )$$

without considering phase differences. High values next to one indicate a distinct modulation, whereas low values next to zero indicate absence of modulation. According to an example embodiment, either Equation (6) or Equation (7), disclosed above, may be employed to determine a modulation feature that checks for modulation in a specific way, that is, by detecting the 180° phase shift to determine whether speech is present.

Post-Processing

Based on results from experiments disclosed herein, it may be observed that an example embodiment of the VAD feature is robust against various types of interferences, such as various types of interferences in automotive environments. According to an example embodiment, an alternating structure of speech that is considered by the feature is quite specific. A high confidence that speech is actually present in the signal can be expected when the example embodiment of the VAD feature indicates speech. However, even during the presence of speech the example embodiment of the VAD feature may not permanently assume high values, as speech signals don't consistently exhibit this alternating energy (i.e., power concentration) characteristic in the first and second frequency bands or, alternatively, an alternating concentration of harmonic components in the first frequency band and a concentration of power in the second frequency band, as disclosed above with reference to FIG. 5. Therefore, according to an example embodiment, basic post-processing may be employed that temporally extends the detections, for example, by 0.5 seconds or any other suitable value. As such, an example embodiment of a VAD feature, such as MPD ( [symbol] ), disclosed above, may be used to control other VAD features, such as MPD_{holdtime} ( [symbol] ), disclosed below.

According to an example embodiment, maximum values may be held for some frames, e.g., by

$${MPD}_{hold time} ( 𝓁 ) = {max}_{0 \leq 𝓁 < {L}^{′}} MPD ( 𝓁 - {𝓁}^{′} ) \qquad ( 9 )$$

to implement a hold time. With this mechanism, the example embodiment may start to detect speech when the expected characteristic occurs. However, a duration of detection is fixed by a parameter L′. As such, to better react on an end of speech, a combination with another feature may be employed according to an example embodiment.

An example embodiment may use a combination of different features to take advantage of capabilities of the different features. According to an example embodiment, in an event MPD with hold time, that is, MPD_{holdtime} ( [symbol] ), disclosed above, indicates speech, a high confidence that speech was actually present during the previous L′ frames may be assumed. Using this information, another feature can be controlled. As such, an example embodiment of a VAD feature, such as MPD_{holdtime} ( [symbol] ), disclosed above, may be used to control other VAD features, such as MOD( [symbol] ), as disclosed by COMB( [symbol] ), disclosed below. For example, if MPD_{holdtime} ( [symbol] ) results in a low value, the effect of the MOD( [symbol] ) value may be limited. A higher value of the MOD( [symbol] ) feature may be required before the value of the COMB( [symbol] ) feature, disclosed below, exceeds a given threshold. Thus, a false speech detection rate may be reduced compared to the MOD( [symbol] ) feature without the MPD_{holdtime} ( [symbol] ) feature.

An example embodiment may combine MPD with hold time with MOD using a multiplication:

COMB( [symbol] )=MPD_{hold time}( [symbol] )·MOD( [symbol] ). (10)

According to an example embodiment, such a combination prevents MOD from detection when MPD did not indicate speech during the previous frames. On the other hand, the end of speech can be detected according to embodiments disclosed herein by taking the MOD feature into account. The combination, therefore, adopts the high robustness of MPD and the possibility of MOD to react to the end of speech.

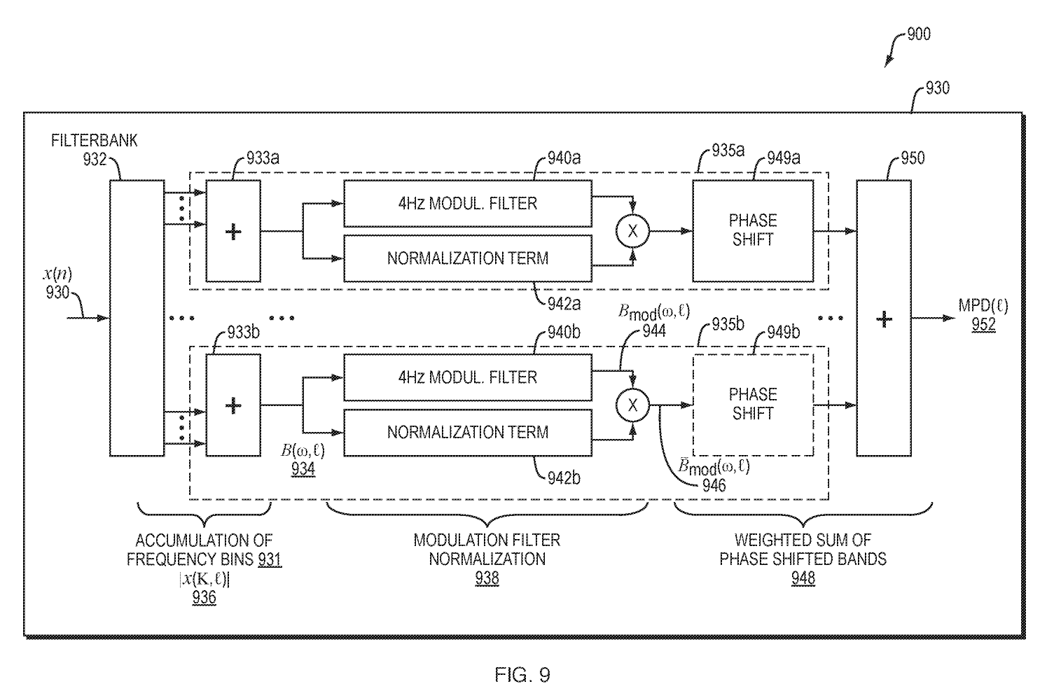

FIG. 9 is a block diagram 900 of an example embodiment of a system 930 for producing a VAD feature MPD ( [symbol] ) 952 for detecting speech in an audio signal x(n) 930. The system 930 may include an accumulation of frequency bins section 931. The accumulation of frequency bins section 931 may include a filterbank 932 to produce a frequency representation, such as shown in the spectrogram 200 of FIG. 2A, disclosed above, that may be the frequency representation of an audio signal x(n) 930 in terms of frequency bins, where n represents the sample index. Bins of a magnitude spectrum |X(k, [symbol] )| 931 of the audio signal x(n) 930 may be accumulated with accumulators 933a and 933b along frequency bins k to obtain subsequent frequency bands B(w, [symbol] ) 934:

$${\sum }_{k = {k}_{min} ( w )}^{{k}_{max} ( w )} \vert X ( k , 𝓁 ) \vert ,$$

as employed in Equation (1), disclosed above, where k denotes the frequency bin and [symbol] denotes the current frame.

As disclosed above with regard to Equation (1), two frequency bands w ∈ {1,2} that capture low frequencies [200 Hz, 2 kHz] and high frequencies [4.5 kHz, 8 kHz] corresponding to voiced and unvoiced speech, respectively, may be employed. As such, the system 930 includes two paths, a first path 935a and a second path 935b, each corresponding to a particular frequency band of the two frequency bands. Frequency bins kₘᵢₙ and kₘₐₓ may be chosen that correspond to the cut-off frequencies of the two frequency bands, so that low frequency components (primarily voiced speech portions) and high frequency components (primarily unvoiced speech portions) may be captured by the separated frequency bands.

The system 930 may further include a modulation filter and normalization section 938. The modulation filter and normalization section 938 may include a first 4 Hz modulation filter 940a and normalization term pair 942a employed in the first path 935a and a second 4 Hz modulation filter 940b and normalization term 942b pair employed in the second path 935b. In the 4 Hz modulation filters 940a and 940b, a typical syllable rate of speech (e.g., 4 Hz) may be considered by applying a filter:

$${H}_{mod} ( z ) = \frac{1 - β}{\underbrace{1 - {e}^{2 π j Ω} mod {β z}^{- 1}}_{Modulation}}$$

along time for each frequency band. An infinite impulse response (IIR) filter may emphasize the modulation frequency:

Ω_{mod} [symbol] 4 Hz

and attenuate all other frequencies. A parameter of:

β [symbol] −3 dB/cycle

may be used to control decay of the impulse response. Resulting complex-valued signals B_{mod}(w, [symbol] ) 944, such as:

B_{mod}(w, [symbol] )=(1−β)B(w, [symbol] )+βe^{2πjΩ}^{_{mod}}B_{mod}(w, [symbol] −1),

represent strength and phase of the modulation.

The 4 Hz modulation filters 940a and 940b may be extended by a high-pass and low-pass filter to achieve a stronger suppression of the influence of the stationary background (i.e., modulation frequency 0 Hz), as well as highly fluctuating components (i.e., modulation frequency >>4 Hz):

$${H}_{mod} ( \approx ) = \frac{1 - β}{\underbrace{1 - {e}^{2 πjΩ} {mod β z}^{- 1}}_{Modulation}} \cdot \frac{( 1 + β ) ( 1 - {z}^{- 1} )}{\underbrace{( 1 - {β z}^{- 1} ) ( 1 + 1 )}_{HP}} \cdot \underbrace{\frac{1 + {z}^{- 1}}{1 + 1}}_{LP}$$

The magnitudes of the complex-valued signals B_{mod}(w, [symbol] ) 944 depend on a power of the input signal x(n) 930. To remove this dependency and to emphasize phase information, normalization \tilde{B}_{mod}(w, [symbol] ) 946 may be applied, for example:

$${\tilde{B}}_{mod} ( w , 𝓁 ) = \frac{{B}_{mod} ( w , 𝓁 )}{\vert {B}_{mod} ( w , 𝓁 ) \vert} .$$

Alternatively, by normalization with respect to the second moment ( [symbol] power) in each frequency band, that is:

$${\tilde{B}}_{mod} ( w , 𝓁 ) = \frac{{\overline{B}}_{mod} ( w , 𝓁 )}{\sqrt{\overline{{B}^{2}} ( w , 𝓁 )}} with$$

$$\overline{{B}^{2}} ( w , 𝓁 ) = ( 1 - β ) {B}^{2} ( w , 𝓁 ) + β \overline{{B}^{2}} ( w , 𝓁 - 1 )$$

enables a contribution of the 4 Hz modulation to the complete power to be taken into account.

The system 930 may further include a weighted sum of phase shifted bands section 948. In the weighted sum of phase shifted bands section 948, one of the phase shifters 949a and 949b may be employed for shifting the normalized \tilde{B}_{mod}(w, [symbol] ) of one of the frequency bands, such as the normalized \tilde{B}_{mod}(w, [symbol] ) 946 in the second path 935b. Either of the phase shifters 949a or 949b may be employed to detect a 180° phase difference between the lower and higher frequency bands for detecting the alternating pattern. According to an example embodiment, in an event the 180° phase difference is not detected, noise may be assumed. As such, according to an example embodiment, a VAD feature, such as the modulation-phase difference (MPD) feature MPD( [symbol] ) 952, may be designed to not only detect a modulation frequency but to also detect a phase shift of, for example, 180° between the high and low frequency bands.

In the weighted sum of phase shifted bands section 948, the normalized complex-valued signals \tilde{B}_{mod}(w, [symbol] ) 946 from different bands, that is, from the paths 935a and 935b, may be combined via a combiner 950 to generate the modulation-phase difference feature MPD( [symbol] ) 952 using a weighted sum:

$$MPD ( 𝓁 ) = \frac{\vert {\sum }_{w} {σ}_{w} \cdot {\tilde{B}}_{mod} ( w , 𝓁 ) \vert}{{\sum }_{w} \vert {σ}_{w} \vert} .$$

According to an example embodiment, weighted coefficients may be chosen so that the expected phase differences of 180° between the lower and higher frequency bands may be compensated, for example, for four frequency bands or σ₁=1, σ₂=0.5, σ₃=−0.5, σ₄=−1. Alternatively, by taking into account the magnitude as well as the phase difference, the alternating excitation of low and high frequencies may be detected as in Equation (6), disclosed above.

Advantages of the example embodiment of the system 930, disclosed above, and other example embodiment disclosed herein, include increased robustness against various types of noise by considering speech characteristics. According to example embodiments, a computationally low-complex VAD feature may be produced because only a few frequency bands are considered. According to an example embodiment, a feature value for VAD may be normalized to the range 0≤MPD( [symbol] )≤1, wherein higher values, such as values closer to one or any other suitable value, may indicate a higher likelihood of presence of speech, and may be independent from input signal power due to normalization. It should be understood that [symbol] indicates a current frame for which the MPD( [symbol] ) may be generated.

Simulations and Results

Simulations disclosed herein employed the UTD-CAR-NOISE database (N. Krishnamurthy and J. H. L. Hansen, “Car noise verification and applications,” International Journal of Speech Technology, December 2013) that contains an extensive collection of car noise recordings. Driving noise as well as typical nonstationary interferences, such as indicator or wiper noise, were recorded in 20 different cars. The noise database is available on a high sampling rate. An example embodiment of the VAD feature was, therefore, evaluated with different sampling rates of fₛ=24 kHz as well as fₛ=16 kHz that are typically employed for ICC applications.

Also, in each car, a short speech sequence—counting from zero to nine—was recorded. This sequence was employed to investigate whether the alternating excitation structure is detected as expected by an example embodiment of the VAD feature. Some digits, such as “six”: “s” (unvoiced) “i” (voiced) “x” (unvoiced), exhibit the alternating structure, whereas others, e.g., “one,” depend purely on voiced phonemes. The expectation was that only digits with alternating structure can be detected.

As a basic VAD approach, a threshold was applied to an example embodiment of the VAD feature value, as the VAD feature value may be a soft feature value indicating a likelihood value as opposed to a hard result that may be a boolean value. Detection rate P_{d} and false-alarm rate P_{fa} are common measures to evaluate VAD methods (J. Ramirez, J. M. Górriz, and J. C. Segura, “Voice Activity Detection. Fundamentals and Speech Recognition System Robustness,” in Robust Speech Recognition and Understanding). The speech sequence was manually labeled to determine the ratio P_{d} between the number of correctly detected frames and the overall number of speech frames. The false-alarm rate P_{fa} is determined analogously by dividing the number of false alarms with the overall number of non-speech frames.

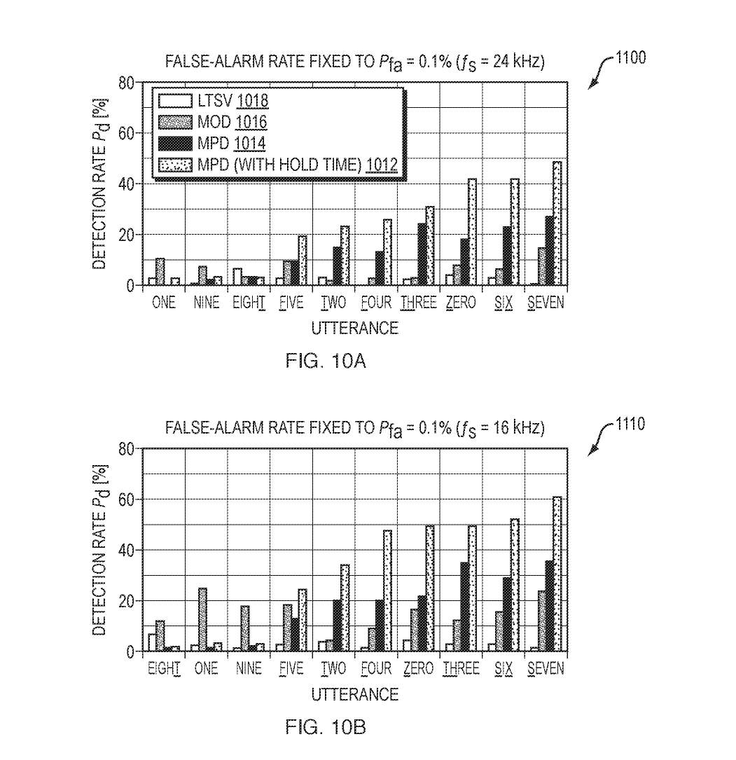

FIGS. 10A and 10B are graphs 1000 and 1010, respectively, of example embodiments of detection rates of different features plotted for a fixed false-alarm rate and two different sampling rates. In addition to the MPD feature with and without hold time (L′ [symbol] 0.5 s), 1012 and 1014, respectively, the modulation feature MOD 1016 as well as the non-stationarity-based LTSV feature 1018 (P. K. Ghosh, A. Tsiartas, and S. Narayanan, “Robust voice activity detection using long-term signal variability,” IEEE Transactions on Audio, Speech, and Language Processing, vol. 19, no. 3, pp. 600-613, 2011) are evaluated. Based on the utterance-selective evaluation, it is noticeable that the MPD feature 1014 is capable to detect speech even for a very low false-alarm rate P_{fa}=0.1%. The analysis confirms that the alternating excitation structure of low and high frequency bands is a distinctive speech property that is robust against interferences. However, only utterances that contain both voiced and unvoiced (underlined) phonemes can be detected using the MPD feature 1014. For both sampling rates fₛ=24 kHz and fₛ=16 kHz employed in FIG. 10A and FIG. 10B, respectively, similar results are achieved.

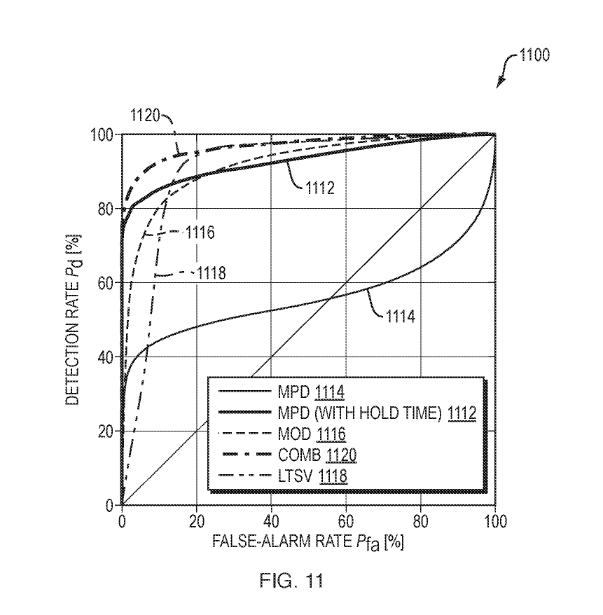

For further simulations, a lower sampling rate of 16 kHz is employed and speech data from the Texas Instruments/Massachusetts Institute of Technology (TIMIT) speech database (J. S. Garofolo, L. F. Lamel, W. M. Fisher, J. G. Fiscus, D. S. Pallet, and N. L. Dahlgren, “DARPA TIMIT Acoustic-Phonetic Continuous Speech Corpus CD-ROM,” 1993) is artificially mixed to the automotive noise. In FIG. 11, disclosed below, Receiver Operating Characteristic (ROC) curves for the different features are plotted. To illustrate the relationship between false-alarms and correct detections, the thresholds are varied and P_{d} is plotted over P_{fa}. One criterion for the performance of VAD features is given by the distance between the curve and the optimal value P_{d}=100%, P_{fa}=0%.

FIG. 11 is a graph 1100 of example embodiments of Receiver Operating Characteristic (ROC) curves for the different features MPD 1114, MPD (with hold time) 1112, MOD 1116, COMB 1120, and LTSV 1118, disclosed above. In FIG. 11, the ROC curves show completely different behaviors for the five features.

MPD can detect speech with a low false-alarm rate. The speech characteristic that is considered is very specific, therefore much speech is missed. By temporally extending the detections using hold time, more speech can be captured by MPD (with hold time). Even with hold time, the false-alarm rate is very low which underlines the robustness of MPD against noise.

LTSV employs the non-stationarity of the signal to detect speech, therefore, it is also triggered by many non-stationary interferences. Using LTSV, very high detection rates can be achieved when accepting these false-alarms as shown by the LTSV ROC curve 1118.

The modulation feature (MOD) ROC curve 1116 lies between the curves of MPD (with hold time) 1112 and the LTSV ROC curve 1118. By combining (COMB) MPD (with hold time) and MOD, the best performance is achieved in this simulation as shown by the COMB ROC curve 1120.

The MPD ROC curve 1114 again shows the robustness of the MPD feature disclosed herein against interferences. On the left side, the slope is very steep, so speech can be detected even for a very low false-alarm rate. Other features, such as LTSV, are less robust against interferences reflected by a less steep slope of the LTSV ROC curve 1118.

As disclosed above, the MPD feature may miss much speech activity due to the very specific speech characteristic that is considered. As such, an example embodiment may employ a hold time, as disclosed above, and the detection rate can be increased without significantly increasing the false alarm rate. In this evaluation, the detection rate for longer utterances is interesting. In contrast to the earlier analysis using the digit sequence, specific elements of a speech sequence are not considered. Therefore, a much longer hold time L′ [symbol] 2 s can be chosen which is beneficial in practical applications.

An example embodiment may combine the MPD feature with the modulation feature, and the results show that the performance can be increased. This combined feature (COMB) outperforms all the other features considered in this analysis as shown by the COMB ROC curve 1120.

Turning back to FIG. 3, disclosed above, the identifying may include employing feature values accumulated in at least one previous frame to identify the pattern of time-separated first and second distinctive feature values. The at least one previous frame may transpire previous to the given frame. For example, an example embodiment may consider temporal context, such as feature values from previous frames, in order to detect the pattern of time-separated first and second distinctive feature values, disclosed above.

Such a temporal context may be captured by considering modulated signal components. For example, the identifying may include computing phase differences between first modulated signal components of the electronic representation of the audio signal in a first frequency band of the at least two different frequency bands and second modulated signal components of the electronic representation of the audio signal in a second frequency band of the at least two different frequency bands, wherein the first frequency band may be lower in frequency relative to the second frequency band.

The identifying may include employing the phase differences computed to detect a temporal alternation of the time-separated distinctive features in the at least two different frequency bands, such as disclosed with reference to Equation (6), disclosed above. The likelihood of the presence of the speech may be higher in response to the temporal alternation being detected relative to the temporal alternation not being detected, and the pattern may be the temporal alternation.

The identifying may include applying a modulation filter to the electronic representation of the audio signal and the modulation filter may be based on a syllable rate of human speech, such as disclosed with reference to Equation (3) disclosed above.

In an event the speech detection result satisfies a criterion for indicating that speech is present, the producing may include extending, temporally, the speech detection result for the given frame by associating the speech detection result with one or more frames immediately following the given frame, such as disclosed with reference to Equation (9), disclosed above.

The speech detection result may be a first speech detection result indicating the likelihood of the presence of the speech in the given frame, such as MPD_{hold time}( [symbol] ), as disclosed above with reference to Equation (9). As disclosed with reference to Equation (10), above, the producing may include combining the first speech detection result MPD_{hold time}( [symbol] ) with a second speech detection result MOD( [symbol] ), indicating the likelihood of the presence of the speech in the given frame, to produce a combined speech detection result COMB( [symbol] ), indicating the likelihood of the presence of the speech in the given frame. The combined speech detection result COMB( [symbol] ) may prevent an indication that the speech is present in the given frame in an event the first speech detection result MPD_{hold time}( [symbol] ) indicates that the likelihood of the presence of the speech is not present at the given frame or during frames previous to the given frame. The second speech detection result MOD( [symbol] ) may be employed to detect an end of the speech in the electronic representation of the audio signal. The combined speech detection result COMB( [symbol] ) enables an improved robustness against false-alarms during absence of speech relative to the first speech detection result MPD_{hold time}( [symbol] ) and the second speech detection result MOD( [symbol] ), as disclosed above with reference to FIG. 11.

The method may include producing the second speech detection result by averaging magnitudes of first modulated signal components of the electronic representation of the audio signal in a first frequency band of the at least two different frequency bands and second modulated signal components of the electronic representation of the audio signal in a second frequency band of the at least two different frequency bands.

Turning back to FIG. 6, disclosed above, the identification module 656 may be further configured to compute phase differences between first modulated signal components of the electronic representation of the audio signal 658 in a first frequency band of the at least two different frequency bands and second modulated signal components of the electronic representation of the audio signal 658 in a second frequency band of the at least two different frequency bands, such as disclosed with reference to Equation (6), disclosed above. The first frequency band may be lower in frequency relative to the second frequency band. The identification module 656 may be further configured to employ the phase differences computed to detect a temporal alternation of the time-separated first and second distinctive features in the at least two different frequency bands. The likelihood of the presence of the speech may be higher in response to the temporal alternation being detected relative to the temporal alternation not being detected. The pattern may be the temporal alternation.

The identification module 656 may be further configured to apply a modulation filter (not shown), such as disclosed with reference to Equation (3) disclosed above, to the electronic representation of the audio signal 658. The modulation filter may be based on a syllable rate of human speech.

In an event the speech detection result 662 satisfies a criterion for indicating that speech is present, the speech detection module 660 may be further configured to extend, temporally, the speech detection result 662 for the given frame by associating the speech detection result 662 with one or more frames immediately following the given frame, such as disclosed with reference to Equation (9), disclosed above.

The speech detection result 662 may be a first speech detection result indicating the likelihood of the presence of the speech in the given frame. The speech detection module 660 may be further configured to combine the first speech detection result with a second speech detection result indicating the likelihood of the presence of the speech in the given frame to produce a combined speech detection result indicating the likelihood of the presence of the speech in the given frame. As disclosed with reference to Equation (10), disclosed above, the speech detection module 660 may be further configured to employ the combined speech detection result to prevent an indication that the speech is present in the given frame in an event the first speech detection result indicates that the likelihood of the presence of the speech is not present at the given frame or during frames previous to the given frame. The speech detection module 660 may be further configured to employ the second speech detection result to detection of an end of the speech in the electronic representation of the audio signal 658.

The speech detection module 660 may be further configured to produce the second speech detection result by averaging magnitudes of first modulated signal components of the electronic representation of the audio signal in a first frequency band of the at least two different frequency bands and second modulated signal components of the electronic representation of the audio signal 658 in a second frequency band of the at least two different frequency bands.

The processor 654 may be further configured to generate an enhanced electronic representation of the audio signal based on the first, second, or combined speech detection results. The enhanced electronic representation of the audio signal may be transmitted via another audio interface (not shown) of the apparatus 650 to produce an enhanced audio signal (not shown).

### CONCLUSIONS

According to an example embodiment, a VAD feature may expect a temporally alternating excitation structure of high and low frequencies for speech, such as disclosed with reference to FIGS. 2A and 2B, above. By employing this very specific speech characteristic, a high robustness against various interferences can be achieved. Furthermore, an example embodiment of the VAD feature is capable to deal with a very low spectral resolution. Performance of the example embodiment of the VAD was investigated in various stationary and non-stationary automotive noise scenarios, as disclosed above. According to another example embodiment of the VAD feature, combination with another modulation feature was shown to further improve the performance.

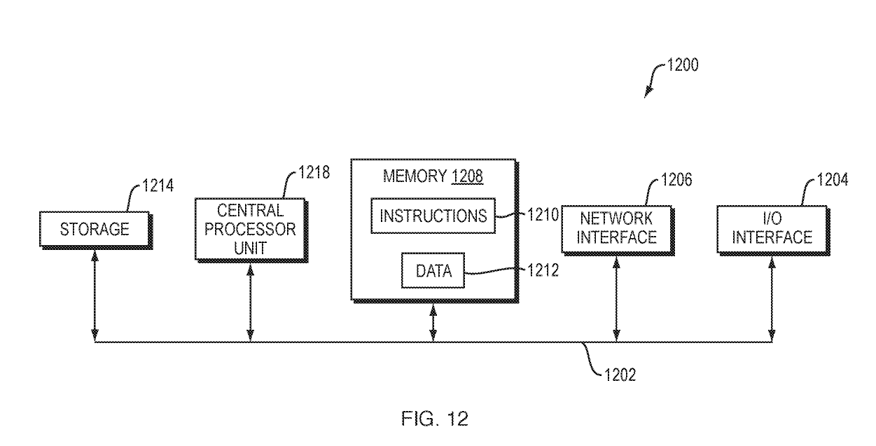

FIG. 12 is a block diagram of an example of the internal structure of a computer 1200 in which various embodiments of the present disclosure may be implemented. The computer 1200 contains a system bus 1202, where a bus is a set of hardware lines used for data transfer among the components of a computer or processing system. The system bus 1202 is essentially a shared conduit that connects different elements of a computer system (e.g., processor, disk storage, memory, input/output ports, network ports, etc.) that enables the transfer of information between the elements. Coupled to the system bus 1202 is an I/O device interface 1204 for connecting various input and output devices (e.g., keyboard, mouse, displays, printers, speakers, etc.) to the computer 1200. A network interface 1206 allows the computer 1200 to connect to various other devices attached to a network. Memory 1208 provides volatile storage for computer software instructions 1210 and data 1212 that may be used to implement embodiments of the present disclosure. Disk storage 1214 provides non-volatile storage for computer software instructions 1210 and data 1212 that may be used to implement embodiments of the present disclosure. A central processor unit 1218 is also coupled to the system bus 1202 and provides for the execution of computer instructions.

Further example embodiments disclosed herein may be configured using a computer program product; for example, controls may be programmed in software for implementing example embodiments. Further example embodiments may include a non-transitory computer-readable medium containing instructions that may be executed by a processor, and, when loaded and executed, cause the processor to complete methods described herein. It should be understood that elements of the block and flow diagrams may be implemented in software or hardware, such as via one or more arrangements of circuitry of FIG. 12, disclosed above, or equivalents thereof, firmware, a combination thereof, or other similar implementation determined in the future. For example, the identification module 656 and the speech detection module 660 of FIG. 6, may be implemented in software or hardware, such as via one or more arrangements of circuitry of FIG. 12, disclosed above, or equivalents thereof, firmware, a combination thereof, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (RAM), read only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method for detecting speech in an audio signal, the method comprising:
identifying a pattern of at least one occurrence of time-separated first and second distinctive feature values of first and second feature values, respectively, in at least two different frequency bands of an electronic representation of an audio signal of speech that includes voiced and unvoiced phonemes and noise, the identifying including associating the first distinctive feature values with the voiced phonemes and the second distinctive feature values with the unvoiced phonemes, the first and second distinctive feature values representing information distinguishing the speech from the noise, the time-separated first and second distinctive feature values being non-overlapping, temporally, in the at least two different frequency bands; and
producing a speech detection result for a given frame of the electronic representation of the audio signal based on the pattern identified, the speech detection result indicating a likelihood of a presence of the speech in the given frame.

2. The method of claim 1, wherein:
the first feature values represent power over time of the electronic representation of the audio signal in a first frequency band of the at least two frequency bands and wherein the first distinctive feature values represent a first concentration of power in the first frequency band;
the second feature values represent power over time of the electronic representation of the audio signal in a second frequency band of the at least two frequency bands and wherein the second distinctive feature values represent a second concentration of power in the second frequency band; and further wherein
the first frequency band is lower in frequency relative to the second frequency band.

3. The method of claim 1, wherein:
the first feature values represent degrees of harmonicity over time of the electronic representation of the audio signal in a first frequency band of the at least two frequency bands and wherein the first distinctive feature values represent non-zero degrees of harmonicity in the first frequency band;
the second feature values represent power over time of the electronic representation of the audio signal in a second frequency band of the at least two frequency bands and wherein the second distinctive feature values represent a concentration of power in the second frequency band; and further wherein
the first frequency band is lower in frequency relative to the second frequency band.

4. The method of claim 1, wherein the identifying includes employing feature values accumulated in at least one previous frame to identify the pattern of time-separated first and second distinctive feature values, the at least one previous frame transpiring previous to the given frame.

5. The method of claim 1, wherein:
the identifying includes computing phase differences between first modulated signal components of the electronic representation of the audio signal in a first frequency band of the at least two different frequency bands and second modulated signal components of the electronic representation of the audio signal in a second frequency band of the at least two different frequency bands; and further wherein
the first frequency band is lower in frequency relative to the second frequency band.

6. The method of claim 5, wherein the identifying includes employing the phase differences computed to detect a temporal alternation of the time-separated distinctive features in the at least two different frequency bands, wherein the likelihood of the presence of the speech is higher in response to the temporal alternation being detected relative to the temporal alternation not being detected, and wherein the pattern is the temporal alternation.

7. The method of claim 1, wherein the identifying includes applying a modulation filter to the electronic representation of the audio signal and wherein the modulation filter is based on a syllable rate of human speech.

8. The method of claim 1, wherein, in an event the speech detection result satisfies a criterion for indicating that speech is present, the producing includes:
extending, temporally, the speech detection result for the given frame by associating the speech detection result with one or more frames immediately following the given frame.

9. The method of claim 1, wherein the speech detection result is a first speech detection result indicating the likelihood of the presence of the speech in the given frame and wherein the producing includes:
combining the first speech detection result with a second speech detection result indicating the likelihood of the presence of the speech in the given frame to produce a combined speech detection result indicating the likelihood of the presence of the speech in the given frame with improved robustness against false-alarms during absence of speech relative to the first speech detection result and the second speech detection result;
wherein the combined speech detection result prevents an indication that the speech is present in the given frame in an event the first speech detection result indicates that the likelihood of the presence of the speech is not present at the given frame or during frames previous to the given frame; and
the combining employs the second speech detection result to detect an end of the speech in the electronic representation of the audio signal.

10. The method of claim 9, further including:
producing the second speech detection result by averaging magnitudes of first modulated signal components of the electronic representation of the audio signal in a first frequency band of the at least two different frequency bands and second modulated signal components of the electronic representation of the audio signal in a second frequency band of the at least two different frequency bands.

11. An apparatus for detecting speech in an audio signal, the apparatus comprising:
an audio interface configured to produce an electronic representation of an audio signal of speech including voiced and unvoiced phonemes and noise; and
a processor coupled to the audio interface, the processor configured to implement:
an identification module configured to identify a pattern of at least one occurrence of time-separated first and second distinctive feature values of first and second feature values, respectively, in at least two different frequency bands of the electronic representation of the audio signal of speech including the voiced and unvoiced phonemes and noise, wherein to identify the pattern the identification module is configured to associate the first distinctive feature values with the voiced phonemes and the second distinctive feature values with the unvoiced phonemes, the first and second distinctive feature values representing information distinguishing the speech from the noise, the time-separated first and second distinctive feature values being non-overlapping, temporally, in the at least two different frequency bands; and
a speech detection module configured to produce a speech detection result for a given frame of the electronic representation of the audio signal based on the pattern identified, the speech detection result indicating a likelihood of a presence of the speech in the given frame.

12. The apparatus of claim 11, wherein:
the first feature values represent power over time of the electronic representation of the audio signal in a first frequency band of the at least two frequency bands and wherein the first distinctive feature values represent a first concentration of power in the first frequency band;
the second feature values represent power over time of the electronic representation of the audio signal in a second frequency band of the at least two frequency bands and wherein the second distinctive feature values represent a second concentration of power in the second frequency band; and further wherein
the first frequency band is lower in frequency relative to the second frequency band.

13. The apparatus of claim 11, wherein:
the first feature values represent degrees of harmonicity over time of the electronic representation of the audio signal in a first frequency band of the at least two frequency bands and wherein the first distinctive feature values represent non-zero degrees of harmonicity in the first frequency band;
the second feature values represent power over time of the electronic representation of the audio signal in a second frequency band of the at least two frequency bands and wherein the second distinctive feature values represent a concentration of power in the second frequency band; and further wherein
the first frequency band is lower in frequency relative to the second frequency band.

14. The apparatus of claim 11, wherein:
the identification module is further configured to compute phase differences between first modulated signal components of the electronic representation of the audio signal in a first frequency band of the at least two different frequency bands and second modulated signal components of the electronic representation of the audio signal in a second frequency band of the at least two different frequency bands; and further wherein
the first frequency band is lower in frequency relative to the second frequency band.

15. The apparatus of claim 14, wherein the identification module is further configured to employ the phase differences computed to detect a temporal alternation of the time-separated first and second distinctive features in the at least two different frequency bands, wherein the likelihood of the presence of the speech is higher in response to the temporal alternation being detected relative to the temporal alternation not being detected, and wherein the pattern is the temporal alternation.

16. The apparatus of claim 11, wherein the identification module is further configured to apply a modulation filter to the electronic representation of the audio signal and wherein the modulation filter is based on a syllable rate of human speech.

17. The apparatus of claim 11, wherein, in an event the speech detection result satisfies a criterion for indicating that speech is present, the speech detection module is further configured to:
extend, temporally, the speech detection result for the given frame by associating the speech detection result with one or more frames immediately following the given frame.

18. The apparatus of claim 11, wherein the speech detection result is a first speech detection result indicating the likelihood of the presence of the speech in the given frame and wherein the speech detection module is further configured to:
combine the first speech detection result with a second speech detection result indicating the likelihood of the presence of the speech in the given frame to produce a combined speech detection result indicating the likelihood of the presence of the speech in the given frame with improved robustness against false-alarms during absence of speech relative to the first speech detection result and the second speech detection result;
wherein the combined speech detection result prevents an indication that the speech is present in the given frame in an event the first speech detection result indicates that the likelihood of the presence of the speech is not present at the given frame or during frames previous to the given frame; and
wherein the second speech detection result is employed to detect an end of the speech in the electronic representation of the audio signal.

19. The apparatus of claim 9, wherein the speech detection module is further configured to:
produce the second speech detection result by averaging magnitudes of first modulated signal components of the electronic representation of the audio signal in a first frequency band of the at least two different frequency bands and second modulated signal components of the electronic representation of the audio signal in a second frequency band of the at least two different frequency bands.

20. A non-transitory computer-readable medium for detecting speech in an audio signal, the non-transitory computer-readable medium having encoded thereon a sequence of instructions which, when loaded and executed by a processor, causes the processor to:
identify a pattern of at least one occurrence of time-separated first and second distinctive feature values of first and second feature values, respectively, in at least two different frequency bands of an electronic representation of an audio signal of speech that includes voiced and unvoiced phonemes and noise, wherein to identify the pattern the sequence of instructions cause the processor to associate the first distinctive feature values with the voiced phonemes and the second distinctive feature values with the unvoiced phonemes, the first and second distinctive feature values representing information distinguishing the speech from the noise, the time-separated first and second distinctive feature values being non-overlapping, temporally, in the at least two different frequency bands; and
produce a speech detection result for a given frame of the electronic representation of the audio signal based on the pattern identified, the speech detection result indicating a likelihood of a presence of the speech in the given frame.
